(19) United States
(12) Patent Application Publication
(10) Pub. No.: US 2025/0368038 A1
(43) Pub. Date: Dec. 4, 2025

(54) METHOD FOR PROVIDING A FRONT PASSENGER DISPLAY SCREEN REPRESENTATION AND CONTROL DEVICE

(71) Applicant: AUDI AG, Ingolstadt (DE)

(72) Inventor: Sebastien AMBROSETTI, Waidhofen (DE)

(73) Assignee: AUDI AG, Ingolstadt (DE)

(21) Appl. No.: 19/222,310

(22) Filed: May 29, 2025

(30) Foreign Application Priority Data
May 31, 2024 (DE) 10 2024 115 255.9

(51) Int. Cl. B60K 35/22; B60K 35/10; B60K 35/28

(52) U.S. Cl. CPC B60K 35/22; B60K 35/10; B60K 35/28; B60K 2360/146; B60K 2360/148; B60K 2360/162; B60K 2360/182

(57) ABSTRACT

A front passenger display screen representation changeable by active reaction of the driver (gesture, vocalization). An external device (smart phone, pair of headphones) enabled to be used to provide data to generate the front passenger display screen representation.

### CROSS REFERENCE TO RELATED APPLICATIONS

This application is based upon and claims the priority benefit of German Application No. 10 2024 115 255.9 filed on May 31, 2024, the entire contents of which are incorporated by reference herein.

### BACKGROUND

### 1. Field

The disclosure relates to a method for providing a front passenger display screen representation in a motor vehicle guided by a driver and an associated control device, each in two aspects.

### 2. Description of the Related Art

The front passenger display screen representation to be provided may be, in particular, part of a two-part representation, of which another part is provided to the driver of the motor vehicle. This can relate in particular to a so-called dual-view display, as mentioned in DE 10 2022 102 504 B3. The dual-view display consists of pixels which are intermeshed/interwoven with one another, of which one part is oriented toward the driver and the other toward the front passenger. The driver sees (essentially) no light which originates from the pixels for the front passenger, and the front passenger sees (essentially) no light which originates from the pixels for the driver. The pixels are located in a single image surface, but emit selectively in two different directions. The display can additionally enable a touch input in this case (touch display), and can possibly do this separately in the two parts. The input can be assigned either to the driver or the front passenger by detecting which hand approaches the display (from which direction it comes). Entirely different image contents can be visible from the viewing direction (perspective) of driver and front passenger and correspondingly different user inputs can take place.

However, for the purposes of the disclosure, the concept of the two-part representation can also include two completely different display screens being provided to the driver, on the one hand, and to the front passenger, on the other hand, or that two areas are separated on one display screen, on one side (left) for the driver and on the other side (right) for the front passenger, wherein the separating line can be variable. The display screen can be illuminated from the rear, but can also include a projection which projects an image on a specific area (the display screen).

Although a dual-view display is the preferred application, the disclosure can also be implemented if an image representation is to be given exclusively to the front passenger and not to the driver.

Furthermore, the representation can, but does not have to be, designed such that a user can also perform an input with respect to the image representation (so that it is a graphical user interface (GUI)). Such arrangements are typically part of an infotainment system provided in the passenger compartment of a vehicle. Vehicle occupants, such as the vehicle driver and further passengers, can interact with the infotainment system via the display (also designated as a “center information display (CID)” in the context of an infotainment system). The “center information display” is the main means of interaction for the infotainment system here. In particular, it can be shared or used jointly by the driver and front passenger in more recent cockpit architectures.

The aspect that there is the risk of driver distraction or driver inattention with such infotainment systems has already been addressed:

Providing a greater range of available functions to a front passenger than to the driver is known from above-mentioned DE 10 2022 102 504 B9. The device therefore distinguishes between driver and front passenger and adapts the information content.

A method for controlling display contents on an output means of a vehicle is known from DE 10 2018 008 045 A1, wherein the display contents are adapted depending on a degree of automation of a current driving status of the vehicle and on at least one detected status variable with respect to a driver or front passenger.

Finally, DE 10 2021 122 465 A1 discloses a method for adjusting a display screen of a vehicle which is embodied as a dual display usable both by a driver and a front passenger. In this case, displayed display screen contents can be adapted to avoid driver distraction and to preserve the privacy of the driver and/or front passenger, in particular depending on a driving situation, on a determined relationship between driver and front passenger (family member or only taxi customer), and on a detected eye position of the driver or front passenger. In one example, confidential emails can thus only be displayed to the front passenger, wherein, for example, in order that the driver cannot see this content, it can be overlaid with additional light for the driver, which acts at a specific (viewing) angle.

The possibilities in the prior art that the front passenger uses the display screen part intended for him have become more and more restricted.

### SUMMARY

One object of the invention is to avoid restrictions of the experience for the front passenger as much as possible, and to do so while still avoiding driver distraction at the same time.

According to an aspect of the invention a method and a control device is provided.

The control device can be part of a motor vehicle provided according to the invention in both aspects.

The method provided according to an aspect of the invention for providing a front passenger display screen representation in a motor vehicle guided by a driver, providing the front passenger display screen representation as part of a two-part representation, of which another part is provided to the driver of the motor vehicle According to an aspect of the disclosure, a first front passenger display screen representation takes place and a reaction of the driver to the first front passenger display screen representation is determined, which is communicated by a hand movement and/or a finger movement and/or an arm movement and/or a pointing movement and/or which is communicated via a vocalization of the driver, wherein based on a predetermined criterion with respect to the reaction of the driver being met, a change is made from the first front passenger display screen representation to a second front passenger display screen representation.

“Display screen representation” is understood in the present case to mean that a representation takes place with a specific type of representation (brightness of the display screen, colors, for example with white background or with black background) and with specific contents. A change of the representation from a first front passenger display screen representation to a second front passenger display screen representation can, on the one hand, relate to the type of representation (external form), thus changes in the brightness and/or color, and, on the other hand—and this may be preferred—it can also cause a change of the display screen contents.

An aspect of the invention enables the driver to actively defend himself if the first front passenger display screen representation disturbs him. In this way, such a display screen representation can now be provided more individually and can be negotiated, so to speak, between the front passenger and the driver. While some vehicle drivers could already be disturbed by the movement contained in videos, other vehicle drivers may be more tolerant. The front passenger can insofar benefit within the scope of the invention from the fact that the driver possibly accepts those first front passenger display screen representations which a fully automatic system would possibly exclude. This does not exclude that automation also still runs in the background, according to which, even if the driver has not shown any reaction as such to indicate that he feels disturbed, the second front passenger display screen representation is nonetheless provided. In the case of a longer distraction of the driver, for instance, it is thus possible to change in an automated manner to a calmer second front passenger display screen representation provided with subtler colors, etc. With dual-view display, the driver does not see the display screen representation for the front passenger, but an operating action of the front passenger on the jointly used display surface may disturb him. If the reaction of the driver is expressed accordingly, by changing to the second front passenger display screen representation, the operating action can be made impossible or (possibly also depending on the driver display screen representation) can be shifted to a display screen part located closer to the front passenger or can be delayed.

According to an embodiment of the invention, the second front passenger display screen representation is identical to a driver display screen representation provided directly to the driver or is part of an overall representation. This means that in a dual-view display, the same image is shown for both perspectives, thus for the driver and the front passenger. It is to be presumed in this case that the image provided to the driver determines what is provided to the front passenger. An overall representation can include in a display different from the dual-view display that a change is made from a divided display screen to a single large image, which is then in turn supposed to be suitable for not distracting the driver from driving or also not giving him the feeling of being distracted.

According to an embodiment of the invention, the vocalization of the driver is semantically analyzed (thus for words) and the use of predetermined terms is considered in checking whether the predetermined criterion has been met. Typical terms can include the driver saying “halt!”, “stop!”, “quiet!”, “no!”, etc. The terms can be determined by a device for providing artificial intelligence in the motor vehicle, for example, the predetermined terms can be terms typically used by the vehicle driver. The terms can insofar be the result of training the device (“learning”) to provide artificial intelligence, which can include, for example, a neural network or a plurality of coupled neural networks.

According to an embodiment of the invention, the vocalization is (maybe preferably: also) analyzed for emotional content and the result of the analysis is taken into consideration when checking whether the predetermined criterion is met. For example, it can be detectable by a device for providing artificial intelligence, which can contain a neural network or a plurality of coupled neural networks, for example, whether the fundamental tone is more aggressive or friendly. If there is a vocalization which sounds aggressive, the front passenger display screen representation is changed from the first representation to the second one, so that the driver is disturbed less thereby.

In the check as to whether a predetermined criterion is met, a passage of time can also play a role. For example, if the first front passenger display screen representation has already been displayed for a certain amount of time (for example, for more than 5 seconds), a negative vocalization can initially be ignored or at least checked for a repetition, which is not necessary before passage of the passage of time. It is thus possible to avoid a negative vocalization made in conversation with the front passenger from incorrectly being related to the first front passenger display screen representation. Similarly, a negative gesture (hand movement/finger movement/arm movement and/or pointing movement) can also only directly induce the change to the second front passenger display screen representation in the context of a predetermined period of time after first provision of the first front passenger display screen representation, but not after passage of the minimum period of time; a second criterion would then possibly need to be met (gesture accompanied by negative vocalization or the like).

The control device according to the invention according to the first aspect actuates a display screen in a motor vehicle, which can be guided by a driver, to provide a front passenger display screen representation. The control device comprises a camera for detecting movements of the driver and/or a microphone for detecting vocalizations of the driver, wherein the control device is coupled and/or provided with a plurality of sources for display screen content (memory having video files, etc.), and wherein it is furthermore designed to analyze data detected by the camera and/or the microphone as to whether the driver states that he does not desire a current front passenger display screen representation, and if so, to change the front passenger display screen representation.

A display screen is also understood here, where appropriate, to mean that an image is projected on a surface (the “display screen”).

The control unit according to an aspect of the invention is used to carry out the method according to the invention. The method provided according to the second aspect of the invention for providing a front passenger display screen representation in a motor vehicle guided by a driver, in particular as part of a two-part representation, in which another part is provided to the driver of the motor vehicle, includes that data are dubbed from an external device (which will generally belong to the front passenger himself) to a control device to generate the front passenger display screen representation and that the front passenger display screen representation uses the dubbed data.

The coupling of external devices such as smart phones with the vehicle is known per se, if a vehicle driver wishes to make a telephone call. The invention expands this aspect with the option of dubbing data by the front passenger and providing a corresponding front passenger display screen representation in the vehicle. In this way, the options of the front passenger for using the display screen representation for himself are expanded.

According to one aspect, the data dubbed from the external device remain at least partially disregarded in a driver display screen representation provided directly to the driver. This means that the dubbed data are used at least partially (and maybe preferably entirely) exclusively for the front passenger display screen representation, so that a certain degree of privacy is retained here.

According to an embodiment of the invention, the external device is a telephony device, in particular a smart phone, a smartwatch, or the like, and the front passenger display screen representation comprises an image of a person having a telephone call with the front passenger via the telephony device.

Of course, data such as the list of the contacts from the smart phone/the telephony device can also be transmitted to the control device for the display screen for the front passenger and represented thereby before, during, and after the telephone conversation.

According to an embodiment, the external device comprises an audio output device, in particular a headphone/pair of headphones, and information related to audio outputs are provided via the front passenger display screen representation. The information related to the audio outputs can include, for example, video data which are associated with the audio data. In this way, it is made possible for the front passenger to watch films and listen to the soundtrack separately as such. Alternatively to providing a headphone, the output device can also include loudspeakers in the vehicle interior which only play in a targeted manner to the front passenger, for example, wherein it is ensured by specific measures that corresponding sound does not reach the driver or reaches the driver at lower volume, for example by using counter noise.

The control device according to an aspect of the invention for a display screen in a motor vehicle, which can be guided by a driver, for providing a front passenger display screen representation comprises a coupling device for the coupling (preferably wireless, for example taking place via Bluetooth® or the like) of an external device, and it comprises a device for receiving data from a device coupled via the coupling device, wherein the control device is designed to use data thus received as a source for image content for generating the front passenger display screen representation.

For applications or application situations which may arise in the method and which are not explicitly described here, it can be provided that according to the method an error message and/or a request to input user feedback is output and/or a standard setting and/or a predetermined initial status is set.

The invention also includes the control device for the motor vehicle. The control device can have a data processing device or a processor unit, which is configured to carry out an embodiment of the method according to the invention. The processor unit can have for this purpose at least one microprocessor and/or at least one microcontroller and/or at least one FPGA (field programmable gate array) and/or at least one DSP (digital signal processor). In particular a CPU (central processing unit), a GPU (graphical processing unit), or an NPU (neural processing unit) can be used in each case as the microprocessor. Furthermore, the processor unit can have program code which is configured, upon execution by the processor unit, to carry out the embodiment of the method according to the invention. The program code can be stored in a data memory of the processor unit. The processor unit can be based, for example, on at least one printed circuit board and/or on at least one SoC (System on Chip).

The invention also includes refinements of the control device according to the invention which have features as have already been described in conjunction with the refinements of the method according to the invention. For this reason, the corresponding refinements of the method according to the invention are not described once again here.

The motor vehicle according to an aspect of the invention may be preferably designed as an automobile, in particular as a passenger vehicle or truck, or as a bus or motorcycle.

As a further solution, the invention also comprises a computer-readable storage medium, comprising program code which, upon the execution by a computer or a computer network, causes it to carry out an embodiment of the method according to the invention. The storage medium can be at least partially provided as a nonvolatile data memory (for example, as a flash memory and/or as an SSD-solid-state drive) and/or at least partially as a volatile data memory (for example, as a RAM-random access memory). The storage medium can be arranged in the computer or computer network. The storage medium can also be operated, for example, as a so-called app store server and/or cloud server in the Internet. A processor circuit having, for example, at least one microprocessor can be provided by the computer or computer network. The program code can be provided as binary code and/or as assembler code and/or as source code of a programming language (for example, C) and/or as a program script (for example, Python).

The invention also comprises the combinations of the features of the described embodiments. The invention thus also comprises implementations which each have a combination of the features of several of the described embodiments, if the embodiments were not described as mutually exclusive.

### BRIEF DESCRIPTION OF THE DRAWINGS

These and other aspects and advantages will become more apparent and more readily appreciated from the following description of the exemplary embodiments, taken in conjunction with the accompanying drawings of which:

Exemplary embodiments of the invention are described hereinafter. In the figures:

FIG. 1 schematically shows a diagram which illustrates how a display screen can be played in an event controlled manner according to an aspect of the invention;

FIG. 2 shows a sequence of criterion steps passed through in the scope of one embodiment of the method according to an aspect of the invention;

FIG. 3 schematically shows a situation in a vehicle interior having the corresponding components present there for carrying out the method according to the invention according to an embodiment according to an aspect of the invention;

FIG. 4 schematically shows a situation in a vehicle interior having the corresponding components present there for carrying out the method according to the invention according to an embodiment according to an aspect of the invention; and

FIG. 5 schematically shows a situation as in FIG. 4 in a vehicle interior having the corresponding components present there for carrying out a modification of the method according to the invention according to an aspect of the invention.

### DETAILED DESCRIPTION

Reference will now be made in detail to the preferred embodiments, examples of which are illustrated in the accompanying drawings, wherein like reference numerals refer to like elements throughout.

The exemplary embodiments explained hereinafter are preferred embodiments of the invention. In the exemplary embodiments, the described components of the embodiments each represent individual features of the invention to be considered independently of one another, which each also refine the invention independently of one another. Therefore, the disclosure is also to comprise combinations of the features of the embodiments other than those shown. Furthermore, the described embodiments can also be supplemented by further features of the invention already described.

In the figures, identical reference signs each identify functionally identical elements.

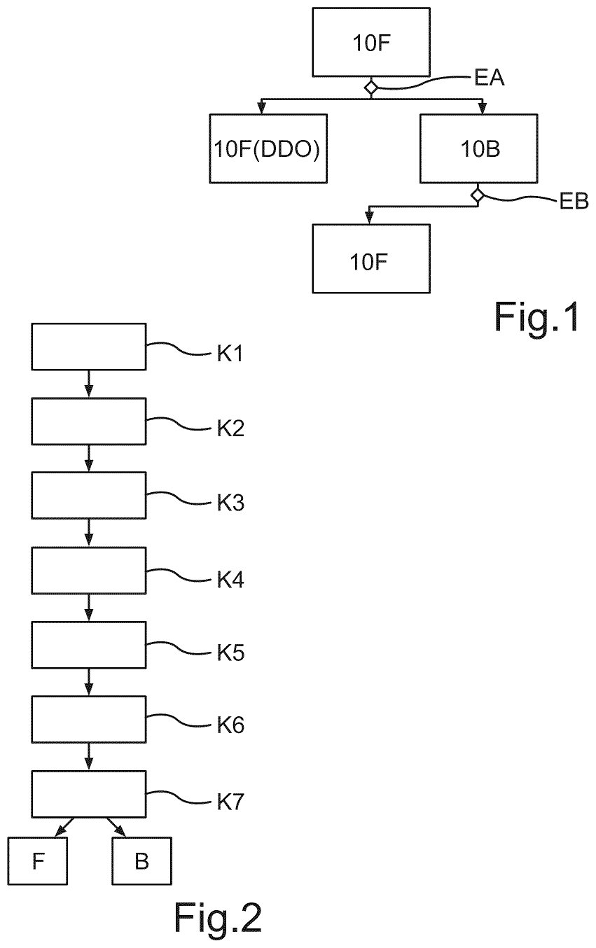

The invention presumes according to FIG. 1 that in a motor vehicle, an image representation is made possible in the cockpit, which is referred to in the present case as a display screen representation. The image representation can be provided by a backlit display screen, which is also designed as a touchscreen, or by a projection or by another measure. In a basic setting, a display screen 10F is shown to both a driver and also the front passenger, this is either as a single large image or duplicated on a respective driver part and front passenger part of the display screen representation. The statements made here on the basis of the drawing apply analogously to dual-view display screen and display screen representations which cannot be represented as well in the drawing. Furthermore, individual display screens can be provided both for the driver and for the front passenger, but it can also be a display screen which can be divided in principle, wherein the boundary for the representation can also be variable. Upon the presence of events EA of the event class A, the display screen is split into a representation 10F′ for the driver, which is optimized to ensure the least possible distraction when driving (DDO: “driver distraction optimized”, optimized with regard to driver distraction). In contrast, a different image 10B is shown to the front passenger. If events of class B are now subsequently present, events EB, a return is made to the original situation and an image 10F″ is shown, which can either be identical with the image 10F or with the image 10F′ or a new image. In the scope of the invention, the events of class A are of less interest. In the scope of the first aspect, this relates to a driver being able to induce an event of class B by active reaction. The scope of the second aspect of the invention relates to the design and the foundations for providing the display screen 10B.

FIG. 2 illustrates a sequence of criterion steps K1, K2, K3, K4, K5, K6, and K7, which are run through, preferably in the sequence mentioned, to check whether an event of class A is present and/or whether an event of class B is present, wherein the criteria can also determine the display screen contents 10F, 10F′, 10B, and 10F″.

The first criterion step K1 relates to the so-called SAE level, thus the driving situation: It is established via vehicle signals or an established velocity whether the driver can respond to the driving task (level L1 or L2) or has to monitor (L3) or not (level L4), or whether the vehicle is parked.

According to the second criterion step K2, it is checked, for example by means of a seat occupancy sensor or a belt buckle sensor, whether a front passenger is located in the motor vehicle at all. In this context, it can also be checked whether the driver and/or the front passenger has registered or has been recognized by means of camera, fingerprint sensor, password, etc. It is checked whether permission has been given on the part of the driver for sensitive contents. For example, a recognized or registered front passenger can be a partner, a child, or a parent, a colleague of the driver or the vehicle owner; it can then be established whether sensitive contents are present or not.

The criterion step K3 includes the question of the driver status: has the driver been distracted for a long time or even dozed off, which can be detected via a driver observation camera? Is he occupied for too long a period of time with the operation of the touch display (touch controller)? Are his eyes on the road (detectable by camera)?

The criterion step K4 includes the question about the mood or the driver emotions: How does the driver react when a hand approaches, for example upon the operation of the display by the front passenger? If the front passenger is currently involved in changing the display screen representation, for example, the driver can react positively or negatively. He may be irritated, surprised, negative, or positive. This can be detected by means of a driver observation camera on the basis of the facial expression of the driver, or by means of microphones and recognition of the pitch of the voice.

The criterion step K5 asks about the contents, for example about applications which are to be opened by the driver and/or by the front passenger. It can be checked in this case whether the content has been optimized for the journey, or who is the responsible party for the contents (company which provides the application (app), company which provides the videos, etc.). In this context, it can also be asked what the source for the contents is, whether it is the so-called “main unit” in the vehicle (thus if the contents are stored on a memory in the vehicle), or whether such contents have been dubbed from a smart phone or another external device onto the vehicle (“mirroring”, “casting” from the app to the vehicle display, thus representation of contents).

The criterion K6 asks about data protection (“privacy step”). This can be linked with the above-mentioned permission. The question can thus be posed as to what the intention of the front passenger is, whether he has connected his smart phone, or a headphone, game controller, and the like via WLAN (Wireless Local Area Network)/Bluetooth® to the vehicle. It can then furthermore be asked whether the “Human Machine Interface” (HMI) has been restricted or temporarily blocked by the system to avoid a current driver distraction. Does the driver possibly need assistance? Can he be assisted by the front passenger in an input, for example in that a destination is searched for in the navigation system, the best route is searched for, in that a music source is searched for in the system, in that a complex setting is changed, messages are answered, or the like takes place such as an information search? Thus, for example, the driver can thus leave it to the front passenger to perform certain tasks with respect to his front passenger display screen representation.

The seventh criterion step K7 includes the question as to whether the image representation is split (thus whether the front passenger display screen representation is only provided for the front passenger or whether it is identical with that shown to the driver). The representation for the driver F or for the front passenger B then results accordingly.

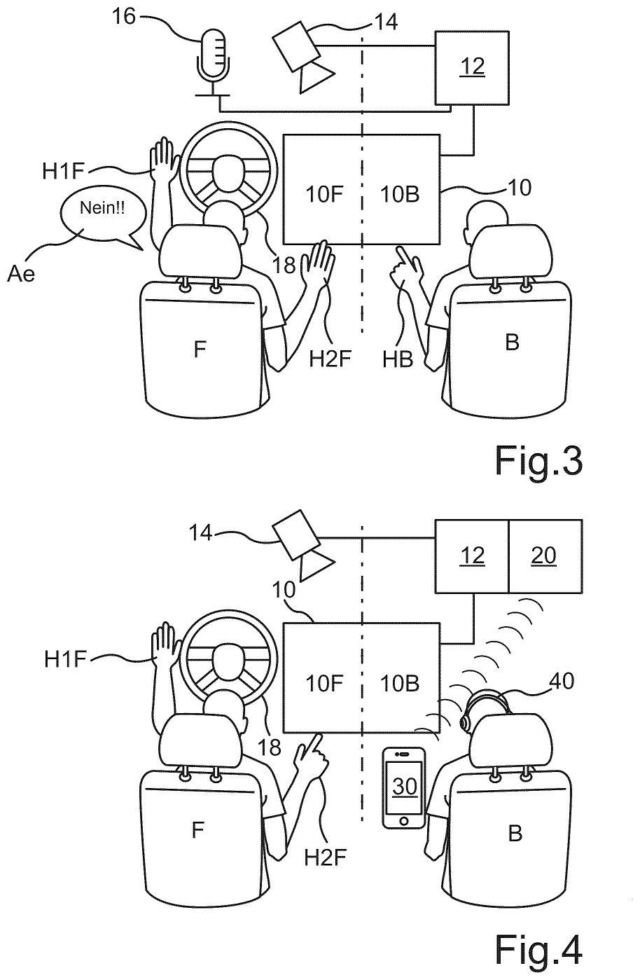

The mentioned aspects can be applied individually or in combination to the examples described hereinafter with reference to FIGS. 3, 4, and 5. For example, it can be provided in the method described with respect to these figures that the additional criteria are at least partially taken into consideration. As an example, it is mentioned that in the context of the question of the occupancy in the criterion step K2, it can have been established which relationship the front passenger has with the driver. The spouse of the vehicle driver can therefore be more permitted to view different contents than the driver on the display screen than is permitted for the children. As a result, in a method which is to restrict the display screen representation, as described with regard to FIG. 3, a degree with respect to an input dimension can be increased in relation to children, for which the degree is to be lower. In the context of the method according to FIG. 3, the vehicle driver can thus prevent using a hand movement a separate display screen from being shown to the front passenger or a display screen which disturbs him being shown. In the case of the spouse (person having high degree of autonomy), it can be provided that the hand movement has to be larger or more explicit than in the case of children, for whom the degree of autonomy is lower. According to the criterion step K1, the SAE level can also play a role, because the source of distractions has to be eliminated faster than otherwise depending on the driver autonomy.

FIG. 3 illustrates a schematic representation of the essential components of a vehicle interior, as is usable in an embodiment of the method according to the first aspect of the invention.

The driver F sits next to the front passenger B and touches the steering wheel 18 with his first hand H1F. Driver F and front passenger B share a display screen 10. A control device 12 (control unit), which is typically located in the motor vehicle, is coupled with a camera 14 and a microphone 16. The front passenger B can perform inputs with his hand HB (if he does not do this acoustically via speech input) and select a first display screen representation. The driver F can then communicate by means of a vocalization Ae (“no!” or the like), which is detectable via the microphone 16, or with a movement of a second hand (preferably imagined as the right hand H2F), which is detected by the camera 14, that he feels disturbed by the first display screen representation. The data detected by the microphone 16 and the camera 14 are supplied to the control device 12, which is conceivable as a device for providing artificial intelligence, which is capable on the basis of complex evaluation mechanisms of checking whether the driver F has made a negative vocalization Ae or a gesture with his hand H2F, in order to then change the display screen representation 10B. The control device 12 thus checks on the basis of the data which are detected by the microphone 16 and the camera 14 whether an event of class B in the sense of FIG. 1 is present, so that the display screen can also be changed in turn. The invention can, but does not have to, include returning to the common display screen 10F″; alternatively, it is also possible to remain with the divided display screen and to only have the display screen representation changed. In this context, the image background can also change from a light color (white) to a dark background (black) and the like.

According to the second aspect of the invention, the front passenger B has an external device shown in FIG. 4, which is embodied here as a smart phone 30, which can be coupled with a coupling device 20 via WLAN or Bluetooth®. It is therefore possible that data are transferred from the smart phone 30 to the control device 12. In this aspect, the front passenger B can watch a film, for example, when video data are transferred from the smart phone 30 to the control device 12. In this context, he can also wear a pair of headphones 40, so that an associated audio output does not disturb the driver F. The driver F can perform inputs during this with his right hand H2F, which are related to his display screen part 10F, wherein these can also be detected by means of a camera 14. The camera 14 can furthermore have further tasks such as detecting excessive fatigue of the driver, etc.

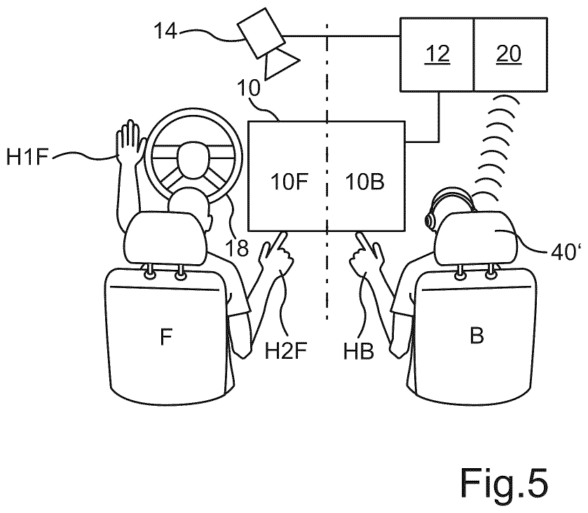

Alternatively to the situation according to FIG. 4, it can be provided as shown in FIG. 5 that the data which ultimately induce the front passenger display screen representation 10B are transferred via a data processing unit integrated in the pair of headphones 40′, so that the pair of headphones 40′ is thus coupled directly with the coupling unit 20 of the control device 12. The front passenger B can perform operations with his hand HB.

Overall, the examples show how a driver/front passenger graphical user interface optimization can be provided upon the use of (in particular) dual-view/touch display.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1. A method of providing a front passenger display screen representation in a motor vehicle enabled to be guided by a driver, comprising:
providing the front passenger display screen representation as part of a two-part representation, of which a part is provided to the driver of the motor vehicle,
determining whether a first front passenger display screen representation as the part of the two-part representation takes place and whether a reaction of the driver to the first front passenger display screen representation occurs, the reaction of the driver being communicated by a hand movement and/or a finger movement and/or an arm movement and/or a pointing movement and/or is communicated via a vocalization of the driver,
wherein based on a predetermined criterion relating to the reaction of the driver is met, a change is made from the first front passenger display screen representation to a second front passenger display screen representation.

2. The method according to claim 1,
wherein the second front passenger display screen representation is identical to a driver display screen representation provided directly to the driver or is part of an overall representation.

3. The method according to claim 1,
wherein the vocalization of the driver is semantically analyzed and use of predetermined terms is taken into consideration when checking whether the predetermined criterion is met.

4. The method according to claim 1,
wherein the vocalization is analyzed for emotional content and a result of the analysis is taken into consideration when checking whether the predetermined criterion is met.

5. A control device for a display screen in a motor vehicle, which is enabled to be guided by a driver, to provide a front passenger display screen representation, having a camera to detect movements of the driver and/or a microphone to detect vocalizations of the driver,
wherein the control device is coupled and/or provided with a plurality of sources for display screen contents and is designed to analyze data detected by the camera and/or the microphone as to whether the driver expresses that the driver does not desire a current front passenger display screen representation and, based on the driver expressing the current front passenger display screen representation is not desired, to change the front passenger display screen representation.

6. A method of providing a front passenger display screen representation in a motor vehicle enabled to be guided by a driver, comprising:
providing the front passenger display screen representation as part of a two-part representation, of which a part is provided to the driver of the motor vehicle,
wherein, data is dubbed from an external device onto a control device to generate the front passenger display screen representation and wherein the front passenger display screen representation uses the dubbed data.

7. The method according to claim 6,
wherein the data remain at least partially unconsidered in a driver display screen representation provided directly to the driver.

8. The method according to claim 6,
wherein the external device is a telephony device and the front passenger display screen representation comprises an image of a person having a telephone call with a front passenger via the telephony device.

9. The method according to claim 8, wherein the telephony device is a smart phone.

10. The method according to claim 6,
wherein the external device comprises an audio output device, and information related to audio outputs is provided via the front passenger display screen representation.

11. The method according to claim 10, wherein the audio output device is a headphone.

12. A control device of a display screen in a motor vehicle, which is enabled to be guided by a driver, to provide a front passenger display screen representation, comprising:
a coupling unit to couple to an external device, and having a device to receive data from the external device while coupled via the coupling unit,
wherein the control device is designed to use data received as a source for image contents to generate the front passenger display screen representation.
